(19) United States
(12) Patent Application Publication
(10) Pub. No.: US 2025/0126175 A1
(43) Pub. Date: Apr. 17, 2025

(54) CONCURRENCY-AWARE SESSION ESTABLISHMENT WITH A WEB-BASED AUTHENTICATION SERVICE

(71) Applicant: Cisco Technology Inc., San Jose, CA (US)

(72) Inventors: Aaron P. Campbell, Hammonds Plains (CA); Weston Andros Adamson, Ann Arbor, MI (US); Bradley A. Kuykendall, Colorado Springs, CO (US); Michael G. Brown, Portland, OR (US); Tyler Charles Hoffman, Ann Arbor, MI (US); Brandon Wong, Montclair, NJ (US)

(21) Appl. No.: 18/488,725

(22) Filed: Oct. 17, 2023

(51) Int. Cl. H04L 67/146; H04L 9/40; H04L 67/141

(52) U.S. Cl. CPC H04L 67/146; H04L 63/083; H04L 67/141

(57) ABSTRACT

The present disclosure is directed to receiving multiple concurrent requests from multiple applications for session establishment from a user device, wherein the concurrent requests originated from a single browser instance, communicating a redirect response comprising a query parameter to each of the applications to the user device, receiving a browser-session synchronization cookie from each of the applications responsive to each corresponding redirect response from the user device, determining a browser-session identifier based on the browser-session synchronization cookies and by a negotiation algorithm, generating a browser-session cookie based on the browser-session identifier and by the negotiation algorithm, and establishing a session for the applications via the single browser instance based on the browser-session cookie.

### TECHNICAL FIELD

The present disclosure generally relates to session management, and more specifically to systems and methods for session management of multiple concurrent requests.

### BACKGROUND

The specifics of how cloud service providers implement session management may affect security outcomes and impact product usability. In particular, single sign-on products have to account for more complex patterns of behavior than single-page web applications. Developing session management for these scenarios while maintaining strong security and wide browser compatibility can be challenging, especially given the limited web APIs and primitives available to synchronize client and server state.

In order to effectively broker access in a web browser context, cloud-native authentication providers may rely on an approach known as session management to track user flows and associate each independent application access back to a single identity. This concept stems from the reliance of the web on HTTP (Hypertext Transfer Protocol), a stateless protocol, such that a separate session layer is needed to allow the provider to map each network request to the same browser instance.

### BRIEF DESCRIPTION OF THE DRAWINGS

FIG. 1 illustrates an example system for concurrency-aware session establishment, in accordance with certain embodiments;

FIG. 2 illustrates an example flow diagram of a negotiation algorithm for concurrency-aware session establishment;

FIG. 3 illustrates an example flow diagram of a method for concurrency-aware session establishment in accordance with certain embodiments; and

FIG. 4 illustrates an example computer system, in accordance with certain embodiments.

### DESCRIPTION OF EXAMPLE EMBODIMENTS

### Overview

According to an embodiment, a system may include one or more processors and one or more computer-readable non-transitory storage media comprising instructions that, when executed by the one or more processors, cause one or more components of the system to perform operations including receiving, from a user device, a plurality of concurrent requests from a plurality of applications for session establishment, and the plurality of concurrent requests originated from a single browser instance; communicating, to the user device, a redirect response comprising a query parameter to each of the plurality of applications; receiving, from the user device, a browser-session synchronization cookie from each of the plurality of applications responsive to each corresponding redirect response; determining, based on the plurality of browser-session synchronization cookies and by a negotiation algorithm, a browser-session identifier; generating, based on the browser-session identifier and by the negotiation algorithm, a browser-session cookie; and establishing, based on the browser-session cookie, a session for the plurality of applications via the single browser instance.

Additionally, the operations for establishing the session for the plurality of applications via the single browser instance may include determining the browser-session cookie matches a valid session and loading the valid session as the session to be established.

Additionally, the operations may include determining the plurality of concurrent requests comprise a plurality of browser-session synchronization cookies. Moreover, the operations for determining the browser-session identifier may include for a first browser-session synchronization cookie of the plurality of browser-session synchronization cookies corresponding to a first concurrent request of the plurality of concurrent requests: determining the query parameter exists on the first concurrent request; determining the first browser-session synchronization cookie is valid; determining, based on a value of the query parameter, a prior session associated with a prior request exists; identifying, based on the value of the query parameter, a prior browser-session identifier associated with the prior request; and selecting the prior browser-session identifier as the browser-session identifier.

Additionally, the operations may include determining the plurality of concurrent requests comprise no browser-session synchronization cookies; generating a random value for the query parameter; generating a browser-session sync-parameter cookie comprising the query parameter associated with the random value; and constructing a uniform resource locator (URL) associated with the browser-session sync-parameter cookie. Moreover, the redirect response may include the browser-session sync-parameter cookie, and the redirect response may be based on the URL.

Additionally, the operations may include determining the plurality of concurrent requests comprise a plurality of browser-session synchronization cookies; determining, for each of the plurality of browser-session synchronization cookies, none of a respective value of the query parameter maps to a prior session; and extracting a browser-session identifier from a first browser-session sync-parameter cookie of the plurality of browser-session synchronization cookies.

Additionally, the operations may include communicating, to the user device, the browser-session cookie for the plurality of applications.

Additionally, the operations may include generating, for the browser-session cookie, at least one of a hash-based message authentication code or a digital signature.

Additionally, the operations may include receiving, from the user device, one or more subsequent requests for session establishment, and the one or more subsequent requests comprise the browser-session identifier; and rejecting the one or more subsequent requests.

According to another embodiment, a method may include the steps of receiving, from a user device, a plurality of concurrent requests from a plurality of applications for session establishment, and the plurality of concurrent requests originated from a single browser instance; communicating, to the user device, a redirect response comprising a query parameter to each of the plurality of applications; receiving, from the user device, a browser-session synchronization cookie from each of the plurality of applications responsive to each corresponding redirect response; determining, based on the plurality of browser-session synchronization cookies and by a negotiation algorithm, a browser-session identifier; generating, based on the browser-session identifier and by the negotiation algorithm, a browser-session cookie; and establishing, based on the browser-session cookie, a session for the plurality of applications via the single browser instance.

According to yet another embodiment, one or more computer-readable non-transitory storage media may embody instructions that, when executed by a processor, cause the performance of operations, including receiving, from a user device, a plurality of concurrent requests from a plurality of applications for session establishment, and the plurality of concurrent requests originated from a single browser instance; communicating, to the user device, a redirect response comprising a query parameter to each of the plurality of applications; receiving, from the user device, a browser-session synchronization cookie from each of the plurality of applications responsive to each corresponding redirect response; determining, based on the plurality of browser-session synchronization cookies and by a negotiation algorithm, a browser-session identifier; generating, based on the browser-session identifier and by the negotiation algorithm, a browser-session cookie; and establishing, based on the browser-session cookie, a session for the plurality of applications via the single browser instance.

Technical advantages of certain embodiments of this disclosure may include one or more of the following. The systems and methods described herein may remove the complexity around creating multiple sessions that need to be merged later by using a negotiation algorithm to require a unique cookie be returned per concurrent request but defer the creation of the session itself until negotiation of the session identifier is complete. The systems and methods described herein may additionally avoid predictability by choosing session identifiers carefully using a cryptographically secure random-number generator. The systems and methods described herein may further mitigate cross-site-scripting and man-in-the-middle style attacks by exchanging session identifiers via HTTP cookies, over a secure HTTPS connection, and with the “httpOnly” flag set. The systems and methods described herein may also protect the authenticity of session cookies by employing a hash-based message authentication code, digital signature, or similar scheme to mitigate unauthorized use and tampering.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

To establish a session, the server may generate an identifier and return it to the client in a small block of data called a cookie. Although cookies are useful for storing state on the user's device, it may take a full round-trip for the server to confirm receipt of any new state, making it challenging to synchronize identifiers in the face of multiple concurrent requests. In an example scenario, a user quits their browser while several applications are left open, steps away from their computer, then returns and restarts their browser at a later time. Upon restart, the user chooses to restore the prior browsing state, causing the browser to re-create a new window or tab for each of the applications they were using previously. However, since their authorization for these applications has since expired, they are redirected to an identity verification service to re-authenticate, triggering a deluge of simultaneous requests from the browser to the authentication provider.

The problem is, prior to establishing a session, and in the case of multiple concurrent requests, a provider may be unable to reliably group these requests according to the originating browser instance until the session cookie is received by the browser and returned in a follow-up request. As an example and not by way of limitation, on modern networks, it cannot be assumed that all requests sent from the same browser instance are tagged with the same source IP address. Nor is there a guarantee that other browsers and/or computers are not making their own requests in parallel from that same IP address. This situation is unlikely to get any easier as browser vendors continue to prioritize updates designed to protect users' privacy by preventing their browser activity from being tracked and correlated.

To address the aforementioned problem, in the embodiments disclosed herein, an algorithm is implemented on the server side to negotiate a per-browser-instance identifier before allowing the business logic to persist any session-level data. The algorithm may require a unique cookie be returned per concurrent request, but creation of the session itself is deferred until negotiation of the session identifier is complete. In particular embodiments, the algorithm may return an HTTP 307 redirect response to each such request until an identifier is chosen, removing the complexity around creating multiple sessions that need to be merged later. The cookie-based identifiers may be used by all web-based authentication services to track state during a user's authentication attempts and to track data about the user after they have logged into applications. When an authentication service receives an authentication attempt from a new user (i.e., a user with no previous session cookies), it may decide on an identifier for this user in a way that allows multiple tabs in a browser to establish an identifier concurrently without racing and overwriting each other's session cookies.

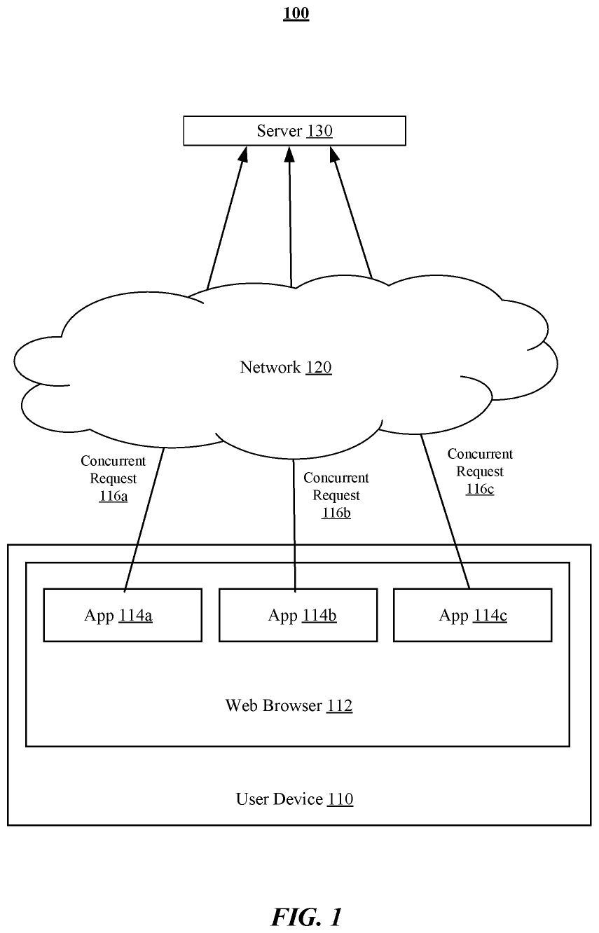

FIG. 1 illustrates an example system 100 for concurrency-aware session establishment, in accordance with certain embodiments. System 100 may include a user device 110, a network 120, and a server 130.

In certain embodiments, the user device 110 may be used by a user to access content from the network 120. Examples of the user device 110 may include a desktop computer system, a laptop or notebook computer system, a mobile telephone (such as a smartphone), a personal digital assistant (PDA), a tablet computer system, and so on. In certain embodiments, the user device 110 may include a liquid crystal display (LCD), an organic light-emitting diode (OLED) flat screen interface, digital buttons, a digital keyboard, physical buttons, a physical keyboard, one or more touch screen components, a graphical user interface (GUI), and the like. The user may further use the user device 110 to receive and respond to certain authentication factors. For example, the user may have an account established with a policy server (e.g., Cisco® Identity Services Engine (ISE)), and the user may have pre-configured the account such that second authentication factors are pushed to an application running on the user device 110. As another example, the user may have an account established with an authentication service, such as Cisco Duo®, and the user may have enrolled a WebAuthn credential with the service using the platform authenticator built into the user device 110.

In certain embodiments, the user device 110 may include a web browser 112. The web browser 112 may be an application software for accessing the World Wide Web. The web browser 112 may be a software program that allows a user to view web pages on the user device 110. The web browser 112 may include a GUI for displaying and navigating between web pages. In some embodiments, the web browser 112 retrieves content from a website's web server and displays the content on one or more devices, such as the user device 110. In certain embodiments, the web browser 112 may be supported by the server 130.

In particular embodiments, a web browser 112 may execute on the user device 110. The web browser 112 may be used by the user to access multiple web applications, e.g., app 114a, app 114b, and app 114c. Although FIG. 1 illustrates a particular number of web applications, this disclosure contemplates any suitable number of applications. For example, the web browser 112 may be used to access more than three web applications. A web application may include a computer program configured to carry out a specific task used by the user. Examples of a web application may include an email application, a media player application, or any other suitable application.

Network 120 of system 100 is any type of network that facilitates communication between components of system 100. Network 120 may connect one or more components of system 100. One or more portions of network 120 may include an ad-hoc network, the Internet, an intranet, an extranet, a virtual private network (VPN), an Ethernet VPN (EVPN), a local area network (LAN), a wireless LAN (WLAN), a virtual LAN (VLAN), a wide area network (WAN), a wireless WAN (WWAN), a software-defined wide area network (SD-WAN), a metropolitan area network (MAN), a portion of the Public Switched Telephone Network (PSTN), a cellular telephone network, a Digital Subscriber Line (DSL), an Multiprotocol Label Switching (MPLS) network, a 3G/4G/5G network, a Long Term Evolution (LTE) network, a cloud network, a combination of two or more of these, or other suitable types of networks. Network 120 may include one or more different types of networks. Network 120 may be any communications network, such as a private network, a public network, a connection through the Internet, a mobile network, a WI-FI network, etc. Network 120 may include a core network, an access network of a service provider, an Internet service provider (ISP) network, and the like. One or more components of system 100 may communicate over network 120.

Server 130 of system 100 may be computer hardware and/or software (e.g., a computer program) that provides authentication services to user devices 110, such as sharing data and/or resources with user devices 110 and/or performing computation for user devices 110. In certain embodiments, server 130 is a security platform that provides authentication services (e.g., MFA, two-factor authentication (2FA), etc.), endpoint security, remote access solutions, device health, and the like.

As illustrated in FIG. 1, app 114a, app 114b, and app 114c may send multiple concurrent requests, e.g., request 116a, request 116b, and request 116c to the server 130 for session establishment. These concurrent requests may be originated from the single web browser 112. The embodiments disclosed herein can effectively establish a session concurrently for these web applications in the web browser 112 responsive to the concurrent requests.

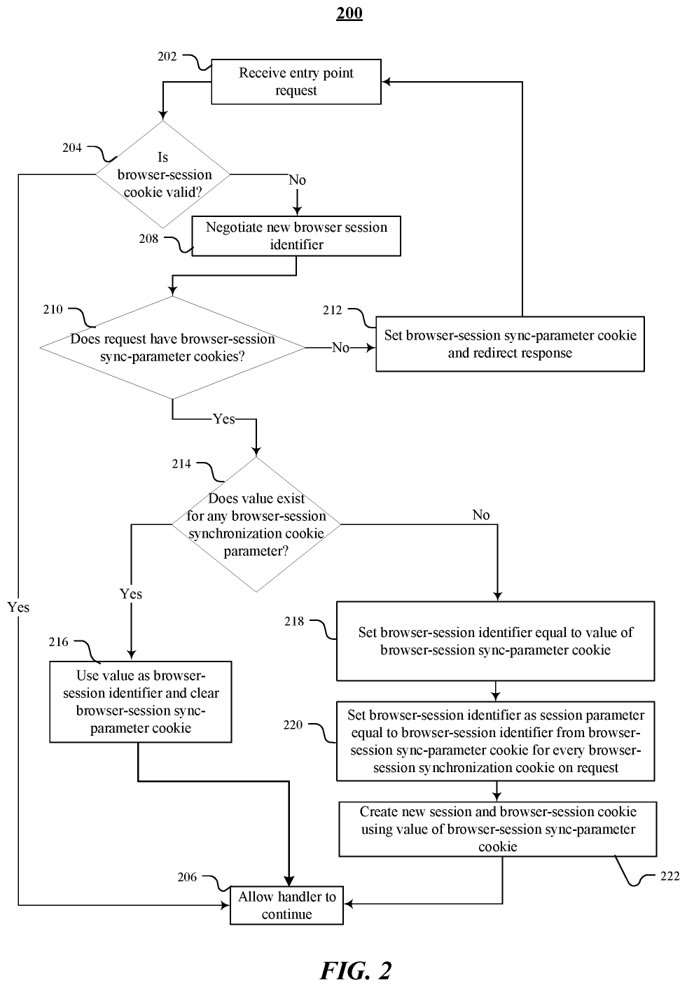

FIG. 2 illustrates an example flow diagram 200 of a negotiation algorithm for concurrency-aware session establishment. The example flow diagram 200 describes the execution of the negotiation algorithm when a request among multiple concurrent requests is received at an authentication entry point of the server 130 to establish a browser-session identifier to be used for tracking authentication states.

Cookie-based identifiers may be used by web-based authentication services to track state during a user's authentication attempts and to track data about the user after they have logged into applications 114. When an authentication service receives an authentication attempt from a new user (i.e., a user with no previous session cookies) it may decide on an identifier for this user in a way that allows multiple tabs in a browser 112 to establish an identifier concurrently without racing and overwriting each other's session cookies.

The example flow diagram 200 illustrates the negotiation algorithm used for establishing and managing session identifiers and mitigating the race conditions that exist in doing so. In particular embodiments, the negotiation algorithm may consider that concurrent requests should settle on a single identifier before being allowed to write data to the session on initial negotiation. This may help prevent issues with allowing multiple tabs to establish different sessions and merging them later. The negotiation algorithm may also consider that session fixation concerns should be solved by tracking data that escalates the privilege of a session cookie (e.g., a token used to signify a user has previously authenticated and does not need to authenticate again for a certain period of time) separate from the cookie tracking non-sensitive session information (e.g., authentication attempt state). In particular embodiments, fixation concerns may be addressed by either regenerating the identifier used to track data when sensitive, privilege escalating information is added, or by tracking this sensitive data via separate cookies. The negotiation algorithm described herein may avoid using identifier regeneration due to the many new race condition situations it introduces.

In particular embodiments, the negotiation algorithm may require one non-expiring cookie and multiple browser-session synchronization cookies during concurrent first use. The non-expiring cookie may be a browser-session cookie with session expiration whose value is a random identifier called the browser-session identifier. Each browser-session synchronization cookie may be a temporary cookie, one per in-flight request to help synchronize browser 112 or server 130. In particular embodiments, all cookies may have a httpOnly flag set, which may prevent client-side JavaScript from accessing their sensitive contents.

At step 202, the server 130 may receive an entry point request. At step 204, the server 130 may determine whether the browser-session cookie is valid. In particular embodiments, the browser-session cookie being valid may indicate the current request comprise a browser-session cookie which is well formed, i.e., decodes properly and contains the correct HMAC (hash-based message authentication) code.

If the browser-session cookie is valid, the server 130 may allow the handler to continue at step 206. In particular embodiments, performing step 206 may comprise extracting the browser-session identifier, determining the browser-session cookie matches a valid session (i.e., the browser-session identifier maps to an active, non-expired session), and loading the corresponding valid session.

If the browser-session cookie is invalid, the server 130 may use the negotiation algorithm to negotiate a new browser session identifier at step 208. At step 210, the server 130 may determine whether the current request comprises browser-session synchronization cookies.

If the current request does not comprise browser-session synchronization cookies, the server 130 may set a browser-session sync-parameter cookie and a redirect response at step 212. In particular embodiments, the server 130 may generate a random value for a session parameter and create a browser-session sync-parameter cookie. As an example and not by way of limitation, the server 130 may set the cookie value to a randomly generated UUID4 hex digest for the new session. The server 130 may not use the randomly generated session-parameter identifier as the browser-session identifier itself since passing it as a query parameter may make it available to JavaScript. In some embodiments, the expiry for the browser-session sync-parameter cookie may be relatively short, since it may be only used for temporary synchronization. In particular embodiments, the server 130 may construct a URL which is the current URL with the session parameter tacked on as a query parameter. The session parameter may not conflict with any existing parameters that may be on the initial request. The server 130 may further return a 307 temporary redirect response using that URL. The flow diagram 200 may then return to step 202.

If the current request comprises browser-session synchronization cookies, the negotiation algorithm may coordinate the following logic. At step 214, the server 130 may determine whether a value exists for any browser-session synchronization cookie parameter. If a value exists, it may indicate the negotiation algorithm found a winning browser-session identifier. At step 216, the server 130 may use the value as the browser-session identifier and clear the browser-session sync-parameter cookie. The flow diagram 200 then proceeds to step 206. If a value does not exist, it may indicate the negotiation algorithm needs to find a new winning browser-session identifier.

In particular embodiments, step 214 may be based on a logic loop. For each browser-session synchronization cookie attached to the request, if the session parameter exists on the request and the cookie is valid, the server 130 may try to load a browser-session identifier for this cookie. If the browser-session identifier exists, it may indicate an earlier request won the race and there is already a new session to use. The server 130 may then clear the browser-session sync-parameter cookie, delete the alias for the session parameter, return the loaded browser-session identifier for the request to use and let the handler continue. If the session parameter does not exist on the request or the cookie is invalid, the negotiation algorithm may continue the loop to the next browser-session synchronization cookie.

If the aforementioned loop is unable to map any of the session parameters on this request to a session, the negotiation algorithm may determine this request won the race. The server 130 may extract the browser-session identifier from the browser-session synchronization cookie. At step 218, the server 130 may set the browser-session identifier equal to the value of the browser-session sync-parameter cookie of this request.

At step 220, the server 130 may set browser-session identifier as session parameter equal to browser-session identifier from browser-session sync-parameter cookie for every browser-session synchronization cookie on request. For each browser-session synchronization cookie that does not match the session parameter, the server 130 may set an alias in a particular data structure to allow racing requests to know which session parameter won.

At step 222, the server 130 may create new session and browser-session cookie using value of browser-session sync-parameter cookie. The server 130 may set a new browser-session cookie with the value of the winning browser-session sync-parameter cookie to finalize the negotiation. The browser-session cookie may use session expiration so it may expire when a user closes their browser 112 and ends the current browser session.

In alternative embodiments, the server 130 may manage multiple concurrent requests for session establishment as follows instead of the negotiation algorithm. All interactions with the authentication service (except for the initial request that renders the bootstrapping HTML document) may be governed by a client-side JavaScript application. In addition, a special endpoint (namely a cookie issuer) may be implemented on the server 130 for issuing new session identifiers. With every request, the server 130 may check the cookie header for a valid session identifier and return a specific error type if it is missing. Upon recognizing this condition, the JavaScript application may intercept the error, acquire an exclusive lock, fabricate a new request to the cookie issuer endpoint to obtain a new cookie, process the result, and resend the original request. In particular embodiments, the exclusive lock may prevent multiple browser requests from racing to acquire a session cookie at the same time. This may remove the need to generate a separate session and cookie for each concurrent request, and in turn the extra logic required to reconcile the resultant round-trip related race conditions. With full control of the client-side behavior through JavaScript, it is possible to pause execution of each browser tab other than the one currently in focus. This may not replace the need for the locking discipline but serve as a complementary technique to reduce the probability of concurrent requests and in turn the likelihood of load spikes on both the user device 110 and server 130.

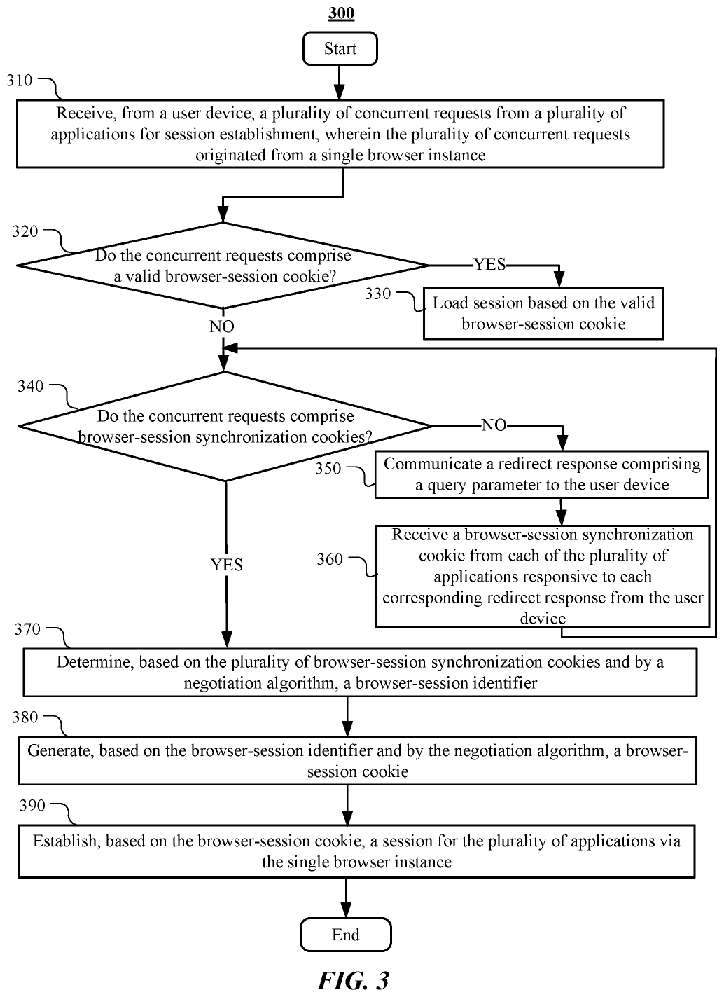

FIG. 3 illustrates an example flow diagram of a method 300 for concurrency-aware session establishment in accordance with certain embodiments. In an embodiment, the steps of method 300 may be performed by a server 130. The method may start at step 310. At step 310, the server 130 may receive, from a user device 110, a plurality of concurrent requests 116 from a plurality of applications 114 for session establishment, wherein the plurality of concurrent requests originated from a single browser instance 112.

At step 320, the server 130 may determine whether the concurrent requests comprise a valid browser-session cookie. If the concurrent requests comprise a valid browser-session cookie, the method may proceed to step 330, where the server 130 may load session based on the valid browser-session cookie by extracting the browser-session identifier from the browser-session cookie, determining the browser-session cookie matches a valid session based on the browser-session identifier, and loading the valid session as the session to be established.

If the concurrent requests do not comprise a valid browser-session cookie, the method may proceed to step 340, where the server 130 may determine whether the concurrent requests comprise browser-session synchronization cookies. If the concurrent requests comprise no browser-session synchronization cookies, the server 130 may communicating a redirect response comprising a query parameter to each of the plurality of applications to the user device 110 at step 350.

In particular embodiments, step 350 may comprise generating a random value for the query parameter; generating a browser-session sync-parameter cookie comprising the query parameter associated with the random value; and constructing a uniform resource locator (URL) associated with the browser-session sync-parameter cookie. In certain embodiments, the redirect response may comprise the browser-session sync-parameter cookie, and the redirect response may be based on the URL.

At step 360, the server may receive a browser-session synchronization cookie from each of the plurality of applications 114 responsive to each corresponding redirect response from the user device 110. The method 300 may then return to step 340.

If the concurrent requests comprise browser-session synchronization cookies, the method 300 may proceed to step 370, wherein the server 130 may determine, based on the plurality of browser-session synchronization cookies and by a negotiation algorithm, a browser-session identifier. In particular embodiments, determining the browser-session identifier may comprise, for a first browser-session synchronization cookie of the plurality of browser-session synchronization cookies corresponding to a first concurrent request of the plurality of concurrent requests: determining the query parameter exists on the first concurrent request; determining the first browser-session synchronization cookie is valid; determining, based on a value of the query parameter, a prior session associated with a prior request exists; identifying, based on the value of the query parameter, a prior browser-session identifier associated with the prior request; and selecting the prior browser-session identifier as the browser-session identifier.

In particular embodiments, the server 130 may determine the plurality of concurrent requests comprise a plurality of browser-session synchronization cookies. The server 130 may then determine, for each of the plurality of browser-session synchronization cookies, none of a respective value of the query parameter maps to a prior session. The server 130 may further extract a browser-session identifier from a first browser-session sync-parameter cookie of the plurality of browser-session synchronization cookies.

Following the regeneration of a browser-session identifier, the server 130 may ensure that subsequent requests presenting an older browser-session identifier are rejected. In particular embodiments, the server 130 may receive, from the user device 110, one or more subsequent requests for session establishment. The one or more subsequent requests may comprise the browser-session identifier. The server 130 may further reject the one or more subsequent requests.

At step 380, the server 130 may generate, based on the browser-session identifier and by the negotiation algorithm, a browser-session cookie. In particular embodiments, the server 130 may further generate, for the browser-session cookie, at least one of a hash-based message authentication code or a digital signature.

At step 390, the server 130 may establish, based on the browser-session cookie, a session for the plurality of applications 114 via the single browser instance 112. The method 300 may then end.

It is to be understood that one or more steps of method 300 may be executed by a server 130. In other embodiments, the method 300 may be executed by one or more components of a system, such as systems 100 described in FIG. 1. In still other embodiments, the method 300 of FIG. 3 may be construed in view of the described system FIG. 1 and processes of FIG. 2.

It is to be understood that the order in which the method 300 is described is not intended to be construed as a limitation, and any number of the described method steps may be combined, modified, or carried out in any order to implement the method 300 or alternative methods. Additionally, individual steps may be deleted from the method 300 without departing from the spirit and scope of the subject matter described herein. Furthermore, the method 300 can be implemented in any suitable hardware, software, firmware, or combination thereof.

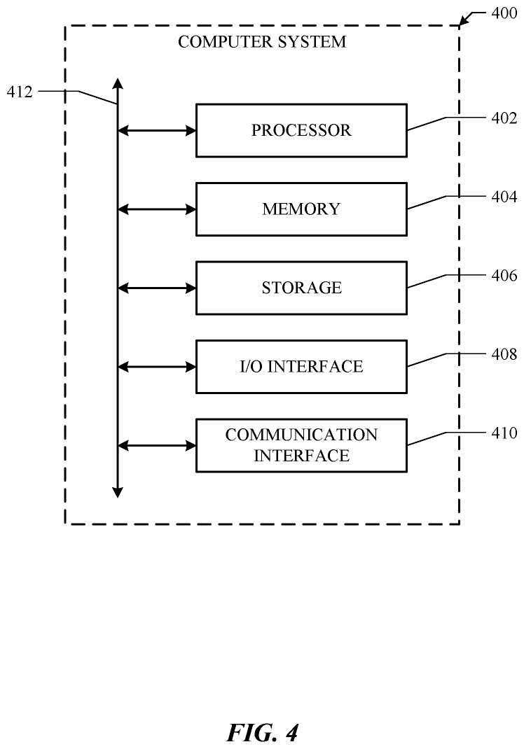

FIG. 4 illustrates an example computer system 400, in accordance with certain embodiments. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The embodiments disclosed herein are only examples, and the scope of this disclosure is not limited to them. Particular embodiments may include all, some, or none of the components, elements, features, functions, operations, or steps of the embodiments disclosed herein. Embodiments according to the disclosure are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

What is claimed is:

1. A system, comprising:
one or more processors; and
one or more computer-readable non-transitory storage media comprising instructions that, when executed by the one or more processors, cause one or more components of the system to perform operations comprising:
receiving, from a user device, a plurality of concurrent requests from a plurality of applications for session establishment, wherein the plurality of concurrent requests originated from a single browser instance;
communicating, to the user device, a redirect response comprising a query parameter to each of the plurality of applications;
receiving, from the user device, a browser-session synchronization cookie from each of the plurality of applications responsive to each corresponding redirect response;
determining, based on a plurality of browser-session synchronization cookies and by a negotiation algorithm, a browser-session identifier;
generating, based on the browser-session identifier and by the negotiation algorithm, a browser-session cookie; and
establishing, based on the browser-session cookie, a session for the plurality of applications via the single browser instance.

2. The system of claim 1, wherein establishing the session for the plurality of applications via the single browser instance comprises:
determining the browser-session cookie matches a valid session; and
loading the valid session as the session to be established.

3. The system of claim 1, wherein the operations further comprise:
determining the plurality of concurrent requests comprise the plurality of browser-session synchronization cookies, wherein determining the browser-session identifier comprises:
for a first browser-session synchronization cookie of the plurality of browser-session synchronization cookies corresponding to a first concurrent request of the plurality of concurrent requests:
determining the query parameter exists on the first concurrent request;
determining the first browser-session synchronization cookie is valid;
determining, based on a value of the query parameter, a prior session associated with a prior request exists;
identifying, based on the value of the query parameter, a prior browser-session identifier associated with the prior request; and
selecting the prior browser-session identifier as the browser-session identifier.

4. The system of claim 1, wherein the operations further comprise:
determining the plurality of concurrent requests comprise no browser-session synchronization cookies;
generating a random value for the query parameter;
generating a browser-session sync-parameter cookie comprising the query parameter associated with the random value; and
constructing a uniform resource locator (URL) associated with the browser-session sync-parameter cookie.

5. The system of claim 4, wherein the redirect response comprises the browser-session sync-parameter cookie, and wherein the redirect response is based on the URL.

6. The system of claim 1, wherein the operations further comprise:
determining the plurality of concurrent requests comprise a plurality of browser-session synchronization cookies;
determining, for each of the plurality of browser-session synchronization cookies, none of a respective value of the query parameter maps to a prior session; and
extracting a browser-session identifier from a first browser-session sync-parameter cookie of the plurality of browser-session synchronization cookies.

7. The system of claim 1, wherein the operations further comprise:
communicating, to the user device, the browser-session cookie for the plurality of applications.

8. The system of claim 1, wherein the operations further comprise:
generating, for the browser-session cookie, at least one of a hash-based message authentication code or a digital signature.

9. The system of claim 1, wherein the operations further comprise:
receiving, from the user device, one or more subsequent requests for session establishment, wherein the one or more subsequent requests comprise the browser-session identifier; and
rejecting the one or more subsequent requests.

10. A method, comprising:
receiving, from a user device, a plurality of concurrent requests from a plurality of applications for session establishment, wherein the plurality of concurrent requests originated from a single browser instance;
communicating, to the user device, a redirect response comprising a query parameter to each of the plurality of applications;
receiving, from the user device, a browser-session synchronization cookie from each of the plurality of applications responsive to each corresponding redirect response;
determining, based on a plurality of browser-session synchronization cookies and by a negotiation algorithm, a browser-session identifier;
generating, based on the browser-session identifier and by the negotiation algorithm, a browser-session cookie; and
establishing, based on the browser-session cookie, a session for the plurality of applications via the single browser instance.

11. The method of claim 10, wherein establishing the session for the plurality of applications via the single browser instance comprises:
determining the browser-session cookie matches a valid session; and
loading the valid session as the session to be established.

12. The method of claim 10, further comprising:
determining the plurality of concurrent requests comprise the plurality of browser-session synchronization cookies, wherein determining the browser-session identifier comprises:
for a first browser-session synchronization cookie of the plurality of browser-session synchronization cookies corresponding to a first concurrent request of the plurality of concurrent requests:
determining the query parameter exists on the first concurrent request;
determining the first browser-session synchronization cookie is valid;
determining, based on a value of the query parameter, a prior session associated with a prior request exists;
identifying, based on the value of the query parameter, a prior browser-session identifier associated with the prior request; and
selecting the prior browser-session identifier as the browser-session identifier.

13. The method of claim 10, further comprising:
determining the plurality of concurrent requests comprise no browser-session synchronization cookies;
generating a random value for the query parameter;
generating a browser-session sync-parameter cookie comprising the query parameter associated with the random value; and
constructing a uniform resource locator (URL) associated with the browser-session sync-parameter cookie.

14. The method of claim 13, wherein the redirect response comprises the browser-session sync-parameter cookie, and wherein the redirect response is based on the URL.

15. The method of claim 10, further comprising:
determining the plurality of concurrent requests comprise a plurality of browser-session synchronization cookies;
determining, for each of the plurality of browser-session synchronization cookies, none of a respective value of the query parameter maps to a prior session; and
extracting a browser-session identifier from a first browser-session sync-parameter cookie of the plurality of browser-session synchronization cookies.

16. A non-transitory computer-readable medium comprising instructions that are configured, when executed by a processor, to:
receive, from a user device, a plurality of concurrent requests from a plurality of applications for session establishment, wherein the plurality of concurrent requests originated from a single browser instance;
communicate, to the user device, a redirect response comprising a query parameter to each of the plurality of applications;
receive, from the user device, a browser-session synchronization cookie from each of the plurality of applications responsive to each corresponding redirect response;
determine, based on a plurality of browser-session synchronization cookies and by a negotiation algorithm, a browser-session identifier;
generate, based on the browser-session identifier and by the negotiation algorithm, a browser-session cookie; and
establish, based on the browser-session cookie, a session for the plurality of applications via the single browser instance.

17. The non-transitory computer-readable medium of claim 16, wherein establishing the session for the plurality of applications via the single browser instance comprises:
determining the browser-session cookie matches a valid session; and
loading the valid session as the session to be established.

18. The non-transitory computer-readable medium of claim 16, further comprising instructions that are configured, when executed by a processor, to:
determine the plurality of concurrent requests comprise the plurality of browser-session synchronization cookies, wherein determining the browser-session identifier comprises:
for a first browser-session synchronization cookie of the plurality of browser-session synchronization cookies corresponding to a first concurrent request of the plurality of concurrent requests:
determining the query parameter exists on the first concurrent request;
determining the first browser-session synchronization cookie is valid;
determining, based on a value of the query parameter, a prior session associated with a prior request exists;
identifying, based on the value of the query parameter, a prior browser-session identifier associated with the prior request; and
selecting the prior browser-session identifier as the browser-session identifier.

19. The non-transitory computer-readable medium of claim 16, further comprising instructions that are configured, when executed by a processor, to:
determine the plurality of concurrent requests comprise no browser-session synchronization cookies;
generate a random value for the query parameter;
generate a browser-session sync-parameter cookie comprising the query parameter associated with the random value; and
construct a uniform resource locator (URL) associated with the browser-session sync-parameter cookie.

20. The non-transitory computer-readable medium of claim 19, wherein the redirect response comprises the browser-session sync-parameter cookie, and wherein the redirect response is based on the URL.
